(19) United States
(12) Patent Application Publication
(10) Pub. No.: US 2021/0374267 A1
(43) Pub. Date: Dec. 2, 2021

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Haruna HIGO, Tokyo (JP); Toshiyuki ISSHIKI, Tokyo (JP); Kengo MORI, Tokyo (JP)

(73) Assignee: NEC Corporation, Minato-ku, Tokyo (JP)

(21) Appl. No.: 16/322,531

(22) PCT Filed: Aug. 7, 2017
(86) PCT No.: PCT/JP2017/028648

§ 371 Date: Feb. 1, 2019

(30) Foreign Application Priority Data
Aug. 19, 2016 (JP) 2016-161326

(51) Int. Cl. G06F 21/62; G06F 21/32; G06F 21/43

(52) U.S. Cl. CPC G06F 21/6227; G06F 21/43; G06F 21/32; G06F 21/6245

(57) ABSTRACT

An information processing device according the present invention includes: a memory; and at least one processor coupled to the memory. The processor performs operations. The operations includes: transmitting a first identifier and a second identifier, which is different from the first identifier and is included in identifiers transmitted to a data management device that stores data in association with an identifier of the data, to the data management device; and selecting the data related to the first identifier from the data related to the first identifier and the second identifier received from the data management device.

### TECHNICAL FIELD

The present invention relates to information processing, and more particularly, to an information processing device, an information processing method, and a recording medium that access data.

### BACKGROUND ART

An authentication method using a password, biological information (for example, information extracted from a living body of a user) or the like has been widely used. For example, a service provider, which provides a user with a service, stores in advance an identifier (ID) related to a user and the like, and authentication data, such as a password, in providing services. Then, when authenticating the user, the service provider collates authentication data associated with an identifier presented by the user in advance and authentication data presented by the user at the time of use.

With the widespread use of cloud computing (hereinafter, called “cloud”), the service provider is configured to provide a service by using a service for managing data by using computer resources which are communicably connected to a communication network. One example of the use of the cloud is that the service provider stores data, which is to be stored in a service for authenticating a user, on a storage of the cloud. In such a case, a user of the service also uses the storage of the cloud.

The user data to be stored for authentication is sensitive information such as a password and biological information in many cases. When the sensitive information is released to the public as is, it causes a privacy problem. That is, the user data is information requiring concealment in many cases. When the data is stored on the storage of the cloud, the leakage of data from the cloud and an illegal act of cloud administrator are concerned. Consequently, even when the user data is stored on the storage of the cloud, there are many cases where concealment is required.

When the user data is concealed using a method such as encryption, even though the user data is stored on the cloud, it is possible to hide the content of the user data.

However, even when the user data is concealed, there is a possibility that information regarding access of the data (for example, information regarding which data has been accessed) from the user is leaked in the cloud (for example, see Non Patent Literature (NPL) 1). Such information regarding access is hereinafter called an “access history”. NPL 1 discloses that privacy information is leaked from the access history to a website that deals with sensitive information such as information regarding assets, information regarding health, or the like.

In this regard, a technology for concealing the access history is proposed (for example, see NPLs 2 and 3).

Oblivious random access machine (ORAM) proposed in NPL 2 is one of the technologies for concealing the access history. The ORAM is a technology for hiding which process is performed on which data with respect to a server in a reading process and a rewriting process of data stored in the server, and a writing process of data to the server.

Alternatively, private information retrieval (PIR) proposed in NPL 3 is one of the technologies for concealing the access history. The PIR is a technology for concealing which data is read with respect to a server in reading of data stored in the server. However, differently from the ORAM, the PIR does not conceal data writing and data rewriting.

When using the technologies related to the ORAM and the PIR, a user of a service can conceal an access history to data stored in the cloud. For example, when information required for authentication is stored on the cloud, a device used by a user operates as a client of the ORAM or the PIR and a device used by a service provider operates as a server of the ORAM or the PIR. By so doing, an access history (for example, accessed data) of a user using the user device (the client) can be concealed with respect to the cloud (the server).

However, all the technologies associated with the ORAM and the PIR proposed so far are inefficient in terms of a size of data stored in the server, calculation amounts of the server and the client, communication traffic and the like. Therefore, it is difficult to actually use the ORAM and the PIR, that is, to put the ORAM and the PIR into practical use.

In this regard, there is proposed a technology capable of accessing data on the server while preventing leakage of an access history to a server without significantly increasing cost of a data capacity, a calculation amount, communication traffic and the like (for example, see Patent Literature (PTL) 1).

In the invention disclosed in PTL 1, information related to extra data is added to a query as well as information on target data of the query.

In the invention disclosed in PTL 1, the target data is concealed in each query by using such a scheme.

### CITATION LIST

### Patent Literature

[PTL 1] International Publication No. 2010/024116

### Non Patent Literature

[NPL 1] Shuo Chen, Rui Wang, XiaoFeng Wang, Kehuan Zhang, “Side-Channel Leaks in Web Applications: A Reality Today, a Challenge Tomorrow”, Proceedings of the 2010 IEEE Symposium on Security and Privacy, IEEE Computer Society, Washington, D.C., USA, 16-19 May 2010, pp. 191-206.
[NPL 2] Oded Goldreich, “Towards a Theory of Software Protection and Simulation by Oblivious RAMs”, STOC '87 Proceedings of the Nineteenth Annual ACM Symposium on Theory of Computing, ACM New York (NY, USA), 1987, pp. 182-194.
[NPL 3] Benny Chor, Eyal Kushilevitz, Oded Goldreich, Madhu Sudan, “Private Information Retrieval”, Journal of the ACM (JACM), Volume 45, Issue 6, ACM New York (NY, USA), November 1998, pp. 965-981.

### SUMMARY OF INVENTION

### Technical Problem

The invention disclosed in PTL 1 is an invention in which extra information is generated and is added to a query as described above.

However, in the invention disclosed in PTL 1, information to be added is data newly generated. That is, in the invention disclosed in PTL 1, the information to be added is information that is not included in a previous query, that is, a past query. Therefore, when target data is data required as the past query, a third party monitoring query communication can narrow down the target data based on a new query and the past query. This is because, in each query, data included in the past query is data to be processed.

In order to improve concealment performance of target data of a query, it is desired to be able to conceal whether target data in the new query coincides with target data in the past query.

For example, user authentication is a process performed many times. That is, authentication data is target data of the past query in many cases. Therefore, in access of data used for authentication, it is important to conceal whether target data of a query coincides with the target data of the past query.

However, in the invention disclosed in PTL 1, it is not possible to conceal whether the target data of the query coincides with the target data of the past query.

As described above, the invention disclosed in PTL 1 has an issue that it is not possible to conceal whether the target data of the query coincides with the target data of the past query.

Since the technologies disclosed in NPLs 1 to 3 increase access cost as described above, it is difficult to put the technologies into practical use in order to solve the above problems.

An object of the present invention is to solve the above issue, and to provide an information processing device, an information processing method, and a recording medium that conceal whether target data of a new query coincides with target data of a past query without increasing access cost.

### Solution to Problem

An information processing device according to one aspect of the present invention includes:

identifier transmission means for transmitting a first identifier and a second identifier that is different from the first identifier in identifiers transmitted to a data management device that stores data in association with an identifier of the data, to the data management device; and

data selection means for selecting the data related to the first identifier from the data related to the first identifier and the second identifier received from the data management device.

An information processing method according to one aspect of the present invention includes:

transmitting a first identifier and a second identifier that is different from the first identifier in identifiers transmitted to a data management device that stores data in association with identifiers of the data, to the data management device; and

selecting the data related to the first identifier from the data related to the first identifier and the second identifier received from the data management device.

A non-transitory computer-readable recording medium according to one aspect of the present invention records a program. The program causes a computer to perform:

a process of transmitting a first identifier and a second identifier that is different from the first identifier in identifiers transmitted to a data management device that stores data in association with identifiers of the data, to the data management device; and

a process of selecting the data related to the first identifier from the data related to the first identifier and the second identifier received from the data management device.

### Advantageous Effects of Invention

According to the present invention, it is possible to achieve an effect that conceals whether target data of a new query coincides with target data of a past query without increasing access cost.

### BRIEF DESCRIPTION OF DRAWINGS

FIG. 1 is a block diagram illustrating an example of a configuration of an information processing device according to a first example embodiment of the present invention.

FIG. 2 is a block diagram illustrating an example of a configuration of an information processing system including the information processing device according to the first example embodiment.

FIG. 3 is a sequence diagram illustrating an example of an operation of the information processing device according to the first example embodiment.

FIG. 4 is a block diagram illustrating an example of a configuration of an information processing device according to an overview of the first example embodiment.

FIG. 5 is a block diagram illustrating an example of a configuration of an information processing device according to a second example embodiment.

FIG. 6 is a sequence diagram illustrating an example of an operation of the information processing device according to the second example embodiment.

FIG. 7 is a block diagram illustrating an example of a configuration of an information processing device according to an example of a hardware configuration.

### EXAMPLE EMBODIMENT

Next, with reference to the drawings, example embodiments of the present invention will be described. Note that each drawing is for describing the example embodiments of the present invention. However, the present invention is not limited to the description of each drawing. Furthermore, in the description of each drawing and the specification, there is a case where similar elements are denoted by the same reference numerals and repetitive description thereof will be omitted. Furthermore, in the drawings used in the following description, there is also a case where elements of a part not related to the description of the present invention are neither described nor illustrated.

Note that, in each example embodiment of the present invention, information (hereinafter, called an “identifier”) for identifying data is not limited. For example, the identifier may be a specific numerical value, a name of data, or an address of data. In the following description, these will be collectively described as an “identifier”.

### First Example Embodiment

Firstly, in order to describe an information processing device 100 according to a first example embodiment of the present invention, an example of an information processing system 300 including the information processing device 100 will be described.

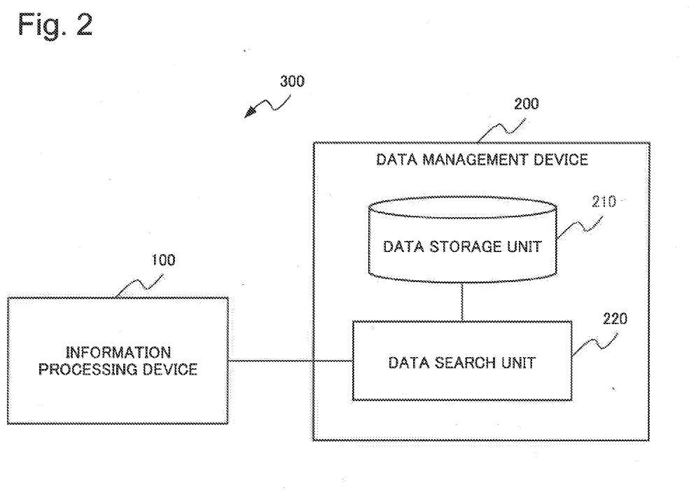

FIG. 2 is a block diagram illustrating an example of a configuration of the information processing system 300 including the information processing device 100 according to the first example embodiment. As illustrated in FIG. 2, the information processing system 300 includes the information processing device 100 according to the first example embodiment and a data management device 200. The information processing device 100 is connected to the data management device 200 via a predetermined communication path (for example, the Internet).

The data management device 200 receives an identifier of target data from the information processing device 100 as a query (an inquiry). Then, the data management device 200 transmits data related to the identifier to the information processing device 100 as a response.

Therefore, the data management device 200 includes a data storage unit 210 and a data search unit 220.

The data storage unit 210 stores data in association with an identifier related to the data. For example, the data storage unit 210 may store a data set including data and an identifier, as data to be stored. Alternatively, the data storage unit 210 may store data and an identifier by using a predetermined database (DB).

The data search unit 220 receives one identifier or a plurality of identifiers from the information processing device 100 as a query. The data search unit 220 searches for data related to the identifiers from the data storage unit 210. Then, the data search unit 220 transmits the searched data to the information processing device 100.

Note that the data search unit 220 transmits data according to specifications of the information processing device 100 as will be described later. For example, when the information processing device 100 identifies data based on an identifier, the data search unit 220 transmits a set of the data and the identifier to the information processing device 100. Alternatively, when the information processing device 100 identifies data based on an order in data communication, the data search unit 220 transmits data according to an order of a received identifier.

The information processing device 100 transmits an identifier related to data to be acquired and an additional identifier to the data management device 200, and receives data from the data management device 200. The information processing device 100 transmits an identifier of target data and an additional identifier such that the target data is concealed as will be described in detail later.

Note that data to be acquired in the information processing device 100 is not particularly limited. For example, this data is data for authenticating a user of the information processing device 100. More specifically, for example, the data is a password or biological information (for example, information extracted from a living body of a user). However, data of the present example embodiment is not limited to the password and the biological information.

Hereinafter, with reference to the drawing, the information processing device 100 will be described in detail.

[Description of Configuration]

Firstly, with reference to the drawing, a configuration of the information processing device 100 will be described.

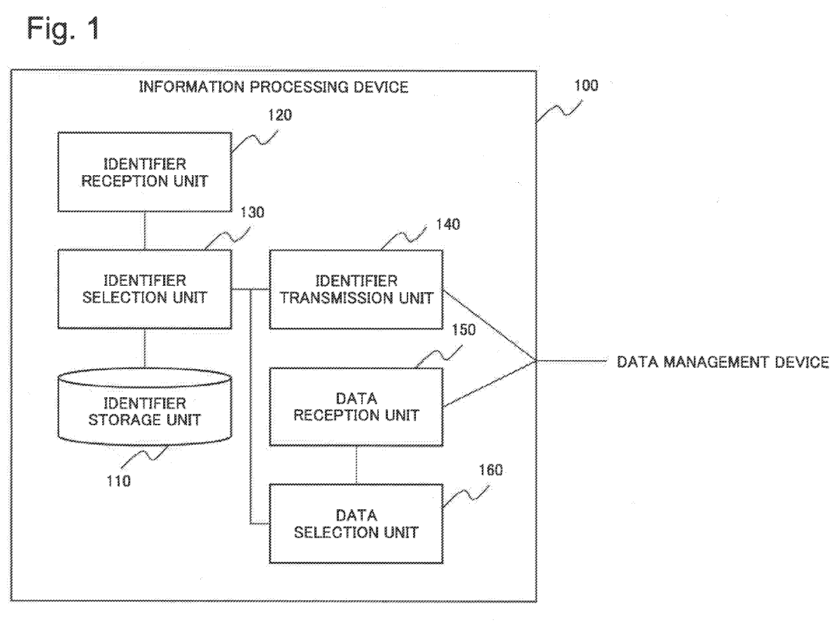

FIG. 1 is a block diagram illustrating an example of a configuration of the information processing device 100 according to the first example embodiment of the present invention. As illustrated in FIG. 1, the information processing device 100 includes an identifier storage unit 110, an identifier reception unit 120, an identifier selection unit 130, an identifier transmission unit 140, a data reception unit 150, and a data selection unit 160.

The identifier reception unit 120 acquires an identifier (hereinafter, called a “target identifier”) of data to be processed from a predetermined device (for example, a user terminal (not illustrated)) or application (for example, application (not illustrated) executed in the information processing device 100). Then, the identifier reception unit 120 transmits the received target identifier to the identifier selection unit 130.

Note that the target identifier is an example of a “first identifier”. Moreover, in the following description, the target identifier is assumed as an identifier that has been transmitted to the data management device 200. Furthermore, the target identifier may be one or more than one.

The identifier storage unit 110 stores an identifier transmitted from the information processing device 100 to the data management device 200. Therefore, the identifier storage unit 110 also stores the target identifier.

Note that the identifier storage unit 110 may store a part of the identifier transmitted from the information processing device 100 to the data management device 200. For example, the identifier storage unit 110 may store a predetermined number of identifiers from identifiers transmitted most recently. Alternatively, the identifier storage unit 110 may store identifiers transmitted in a predetermined time range. Alternatively, the identifier storage unit 110 may store a predetermined number of the identifiers among identifiers transmitted in the predetermined time range.

The identifier selection unit 130 selects an identifier (hereinafter, called a “repeat identifier”), which is different from the target identifier, from the identifiers stored in the identifier storage unit 110. The identifier selection unit 130 selects one identifier or a predetermined number of repeat identifiers.

A technique in which the identifier selection unit 130 selects the repeat identifier is not particularly limited. For example, the identifier selection unit 130 may randomly select the repeat identifier. Alternatively, the identifier selection unit 130 may also select the repeat identifier by using a round-robin method.

Note that the repeat identifier is an example of a “second identifier”.

Note that when the identifier selection unit 130 selects a predetermined number of repeat identifiers, the number of the repeat identifiers is set in the identifier selection unit 130 in advance. However, the identifier reception unit 120 may receive the number of the repeat identifiers in accordance with the reception of the target identifier.

The concealment performance of the target identifier is improved as the number of the repeat identifiers increases. However, a load of the information processing device 100 increases as the number of the repeat identifiers increases. Accordingly, it is sufficient if a user of the information processing device 100 determines a predetermined number in consideration of the concealment performance and the load.

The identifier selection unit 130 transmits the target identifier and the repeat identifier to the identifier transmission unit 140.

The identifier transmission unit 140 generates a query including the target identifier and the repeat identifier, and transmits the query to the data management device 200. That is, the identifier transmission unit 140 transmits the repeat identifier to the data management device 200 in addition to the target identifier.

As described above, the repeat identifier is an identifier transmitted to the data management device 200 in the past query. Also, the target identifier is an identifier transmitted to the data management device 200. Therefore, the data management device 200 is not able to determine the target identifier of identifiers included in a new query. That is, the data management device 200 is not able to determine whether target data of the new query coincides with target data of the past query.

As described above, the information processing device 100 can conceal whether data, which is related to a target identifier to be a target of the new query, coincides with target data of the past query with respect to the data management device 200.

Note that in a query, the identifier transmission unit 140 preferably changes an order of the target identifier and the repeat identifier in a random manner. This operation reduces the specificity of the target identifier. Therefore, based on this operation, the information processing device 100 can further improve the concealment performance of the target identifier. Note that the identifier transmission unit 140 may change the order of the target identifier and the repeat identifier based on a processing rule.

Alternatively, the identifier transmission unit 140 may divide the target identifier and the repeat identifier into a plurality of queries for transmission.

For example, when the number of repeat identifiers is two (hereinafter, assumed as a first repeat identifier and a second repeat identifier) will be described. The identifier transmission unit 140 generates a query including the target identifier and the first repeat identifier as a first query. Next, the identifier transmission unit 140 generates a query including the target identifier and the second repeat identifier as a second query. Then, the identifier transmission unit 140 may transmit the first query and the second query. As described above, the information processing device 100 may transmit the target identifier a plurality of times as well as one time.

Moreover, the identifier transmission unit 140, for example, may generate a query including the target identifier, the first repeat identifier, and the second repeat identifier as a third query, and transmit the third query to the data management device 200. As described above, the information processing device 100 may change the number of repeat identifiers included in a query. Note that the information processing device 100 may change the number of target identifiers included in a query as well as the repeat identifiers.

Alternatively, the identifier transmission unit 140, for example, may generate a query including the first repeat identifier and the second repeat identifier as a fourth query, and transmit the fourth query to the data management device 200. As described above, the information processing device 100 may transmit a query including no target identifier to the data management device 200.

Note that the identifier storage unit 110 may update identifiers to be stored. For example, the identifier storage unit 110 may not store all identifiers transmitted to the data management device 200, and may store a predetermined number of identifiers. In such a case, the identifier storage unit 110 may update a part of the identifiers to be stored by using the target identifier and/or the repeat identifier. Alternatively, when the identifier storage unit 110 stores identifiers transmitted in a predetermined time range, the identifier storage unit 110 may update a part of the identifiers to be stored by using the target identifier and/or the repeat identifier based on the transmission time of the identifiers. For example, the identifier selection unit 130 or the identifier transmission unit 140 may update the identifiers to be stored in the identifier storage unit 110 by using the transmitted target identifier and/or repeat identifier.

The data reception unit 150 receives data related to the target identifier and the repeat identifier from the data management device 200.

The data selection unit 160 selects data related to the target identifier from the received data. Then, the data selection unit 160 transmits the selected data to a transmission source (for example, a user terminal or an application) of the target identifier.

A method, in which the data selection unit 160 selects the data, is not particularly limited. For example, the data selection unit 160 may select the data by using the target identifier. In such a case, the data selection unit 160 may acquire the target identifier from the identifier selection unit 130 or the identifier transmission unit 140 in the selection of the data.

Alternatively, the data selection unit 160 may select the data based on an order of identifiers in the query transmitted by the identifier transmission unit 140.

Note that the data selection unit 160 may perform a predetermined process by using data (hereinafter, called “target data”) related to the target identifier. For example, when data is a password, the data selection unit 160 may compare a password acquired as the target data with a password transmitted together with the target identifier by a transmission source (for example, a user terminal) having transmitted the target identifier, and authenticate the transmission source. That is, based on the target data, the information processing device 100 may also authenticate the transmission source having transmitted the target identifier.

[Description of Operation]

Next, with reference to the drawing, the operation of the information processing device 100 will be described.

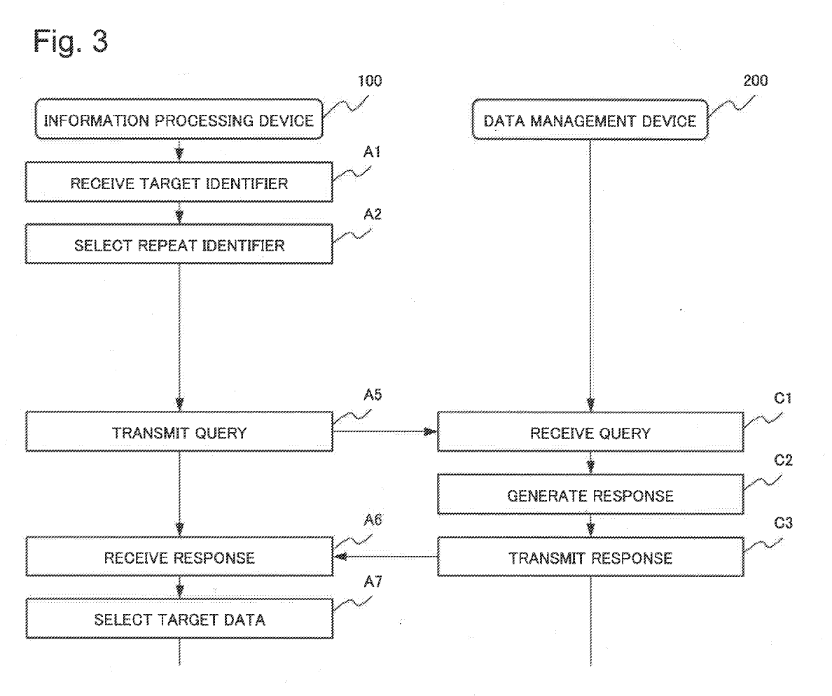

FIG. 3 is a sequence diagram illustrating an example of the operation of the information processing device 100 according to the first example embodiment. In order to clarify the operation, FIG. 3 illustrates an entire operation of the information processing system 300 including the operation of the data management device 200, in addition to the operation of the information processing device 100.

Prior to the operation, it is assumed that the data storage unit 210 of the data management device 200 stores data and an identifier.

Note that data stored in the data management device 200 is not particularly limited. For example, the stored data may be data entrusted by a user who uses the information processing device 100. For example, the stored data may be information (for example, a password or biological information for authenticating a user of a service) stored by a service provider that manages the information processing device 100 to provide the service. Furthermore, the stored data may be encrypted data or unencrypted data.

Moreover, it is assumed that the identifier storage unit 110 of the information processing device 100 stores in advance identifiers transmitted in the past.

The identifier reception unit 120 of the information processing device 100 receives target identifiers of data to be read (A1). A transmission source of the target identifiers, for example, is a user terminal.

The identifier selection unit 130 selects one repeat identifier or a predetermined number of repeat identifiers from the identifier storage unit 110 (A2). However, the identifier selection unit 130 selects the repeat identifiers so as to be different from the target identifiers.

The identifier transmission unit 140 transmits a query including the target identifiers and the repeat identifiers to the data management device 200 (A5). In the query, the identifier transmission unit 140 may change an order of the target identifiers and the repeat identifiers according to a predetermined rule or in a random manner.

Note that when the number of target identifiers is set to “I (I is an integer equal to or more than 1)” and the number of repeat identifiers selected by the identifier selection unit 130 is set to “n (n is an integer equal to or more than 1)”, the query includes I+n identifiers. However, the query may include other information.

The data search unit 220 of the data management device 200 receives the query from the information processing device 100 (C1).

Then, the data search unit 220 searches for data related to the identifiers included in the query from the data storage unit 210, and generates a response in which the searched data is gathered (C2). For example, the response is data including a set of the I+n identifiers and data related to the identifiers. Alternatively, the response may be data arranged in an order of the identifiers included in the query.

The data search unit 220 transmits the response to the information processing device 100 (C3).

The data reception unit 150 of the information processing device 100 receives data as the response (A6).

Then, the data selection unit 160 selects data (target data) related to the target identifier from the data included in the response (A7).

Note that the data selection unit 160 may perform a predetermined process by using the target data as described above.

[Description of Effect]

Next, effects of the information processing device 100 according to the first example embodiment will be described.

The information processing device 100 can achieve an effect that conceals whether target data of a new query coincides with target data of a past query without increasing access cost.

The reason for this is because the information processing device 100 includes the following configuration. That is, the identifier reception unit 120 receives a target identifier. Then, the identifier selection unit 130 selects one repeat identifier or a predetermined number of repeat identifiers, which are different from the target identifier, from identifiers stored in the identifier storage unit 110 and transmitted to the data management device 200 in the past. Then, the identifier transmission unit 140 transmits the target identifier and the repeat identifiers to the data management device 200. Then, the data reception unit 150 receives data related to the target identifier and the repeat identifier. Then, the data selection unit 160 selects data related to the target identifier.

Based on such a configuration, the information processing device 100 transmits the repeat identifier and the target identifier, so that it is possible to conceal an identifier related to data to be a target in the transmitted identifiers.

Moreover, the information processing device 100 selects the repeat identifier from the identifiers transmitted to the data management device 200 in the past, so that it is possible to conceal whether data newly to be a target coincides with past target data.

Moreover, the information processing device 100 transmits the repeat identifier and the target identifier as a query and receives related data, so that it is possible to reduce cost of a data capacity, a calculation amount, communication traffic and the like as compared with the ORAM and the PIR.

### Overview of First Example Embodiment

Next, with reference to the drawing, an overview of the information processing device 100 according to the first example embodiment will be described.

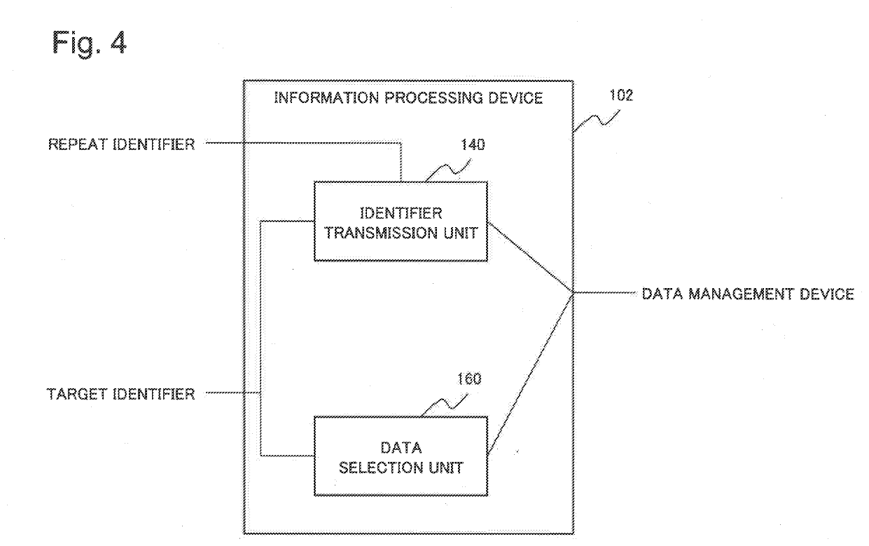

FIG. 4 is a block diagram illustrating an example of a configuration of an information processing device 102 which is an overview of the first example embodiment.

The information processing device 102 includes the identifier transmission unit 140 and the data selection unit 160.

The identifier transmission unit 140 acquires a target identifier and a repeat identifier from an element operating similarly to the identifier selection unit 130 (not illustrated). Alternatively, the identifier transmission unit 140 may read a target identifier and a repeat identifier previously stored in a data storage unit (not illustrated) by the identifier selection unit 130 (not illustrated).

Then, the identifier transmission unit 140 transmits the target identifier and the repeat identifier to the data management device 200. Alternatively, the identifier transmission unit 140 may transmit the target identifier and the repeat identifier to an application (not illustrated) which operates on the information processing device 102 and corresponds to the data management device 200.

That is, the identifier transmission unit 140 transmits the target identifier and the repeat identifier, which is different from the target identifier in identifiers transmitted to the data management device 200, to the data management device 200.

The data selection unit 160 selects data related to the target identifier from data received in an element operating similarly to the data reception unit 150 (not illustrated) from the data management device 200. Alternatively, the data selection unit 160 may select the data related to the target identifier from data previously stored in a data storage unit (not illustrated) by an element operating similarly to the data reception unit 150 (not illustrated). Alternatively, the data selection unit 160 may select the data related to the target identifier from data selected by the application (not illustrated) which operates on the information processing device 102 and corresponds to the data management device 200.

That is the data selection unit 160 selects the data related to the target identifier from data which is related to a target identifier and a repeat identifier and received from the data management device 200.

The information processing device 102 configured as above can achieve effects similar to those of the information processing device 100.

The reason for this is as described above.

The identifier transmission unit 140 of the information processing device 102 transmits the target identifier and the repeat identifier to the data management device 200 or a configuration corresponding to the data management device 200. Therefore, the information processing device 102 can conceal an identifier of target data in identifiers handed over in order to acquire data.

Moreover, the data selection unit 160 selects the data related to the target identifier from data received from the data management device 200 or a configuration corresponding to the data management device 200. Therefore, the information processing device 102 can acquire target data while concealing an identifier of the target data.

Note that the information processing device 102 is a minimal configuration in the example embodiment of the present invention.

### Second Example Embodiment

In the information processing device 100 of the first example embodiment, when target data is data never included in the past query, if all the past queries are used, there is a possibility the target data can be specified. Moreover, when the data management device 200 or a third party monitoring communication knows that the information processing device 100 of the first example embodiment is a device using an identifier used in the past query, this probability increases.

An information processing device 101 according to a second example embodiment does not reduce concealment performance even though target data is new data as will be described below.

Hereinafter, with reference to the drawings, the information processing device 101 according to the second example embodiment will be described.

[Description of Configuration]

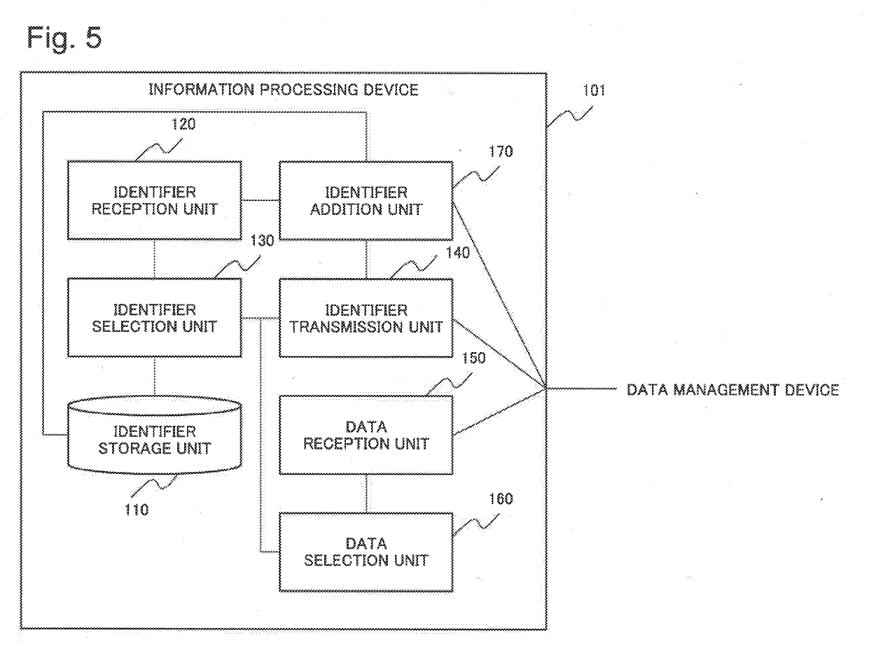

FIG. 5 is a block diagram illustrating an example of a configuration of the information processing device 101 according to the second example embodiment.

The information processing device 101 includes an identifier addition unit 170 in addition to the configuration of the information processing device 100. Therefore, description for a configuration similar to that of the first example embodiment will be omitted and a configuration associated with the identifier addition unit 170 will be described.

The identifier addition unit 170 generates or selects identifiers (hereinafter, called “dummy identifiers”) that are further added as identifiers to be transmitted to the data management device 200, in addition to the target identifiers and the repeat identifiers. However, the identifier addition unit 170 generates or selects identifiers, which are different from the target identifiers and identifiers stored in the identifier storage unit 110, as the dummy identifiers. Note that the dummy identifier is an example of a “third identifier”.

A method in which the identifier addition unit 170 generates or selects the dummy identifiers is not particularly limited.

For example, the identifier addition unit 170 may calculate the dummy identifiers from the target identifiers or the repeat identifiers by using a predetermined formula. Alternatively, the identifier addition unit 170 may use the method disclosed in PTL 1. Alternatively, the identifier addition unit 170 may select the dummy identifiers from identifiers stored in a storage unit (not illustrated).

That is, it is sufficient if the identifier addition unit 170 generates or selects the dummy identifiers different from the target identifiers and identifiers transmitted to the data management device 200. Note that the identifier addition unit 170 may change the number of dummy identifiers to be selected by using a predetermined technique or in a random manner.

However, when the data management device 200 is not able to transmit data related to the dummy identifier, there is a case where the data management device 200 and a third party monitoring communication can determine the dummy identifier by using the above. For example, data for user authentication is normally stored in the data management device 200. Therefore, there is a possibility that an identifier having no data related to the data management device 200 will be determined as the dummy identifier.

In this regard, the identifier addition unit 170 may select the dummy identifier from identifiers stored in the data management device 200. For example, the identifier addition unit 170 acquires identifiers stored in the data storage unit 210 from the data management device 200. Furthermore, it is sufficient if the identifier addition unit 170 uses an identifier which is different from the target identifiers and the identifiers stored in the identifier storage unit 110 from among the identifiers acquired as the dummy identifiers.

In such a case, the information processing device 101 transmits, as the dummy identifiers, the identifiers stored in the data management device 200. Therefore, the information processing device 101 can reduce the probability that the identifiers are determined as the dummy identifiers, with respect to the data management device 200 and the third party.

The identifier transmission unit 140 transmits the dummy identifier to the data management device 200 in addition to the target identifier and the repeat identifier.

Moreover, when the target identifier has not been stored in the identifier storage unit 110, the identifier selection unit 130 or the identifier transmission unit 140 stores the target identifier in the identifier storage unit 110.

Except for the above, each element operates similarly to the first example embodiment.

[Description of Operation]

Next, with reference to the drawing, the operation of the information processing device 101 will be described.

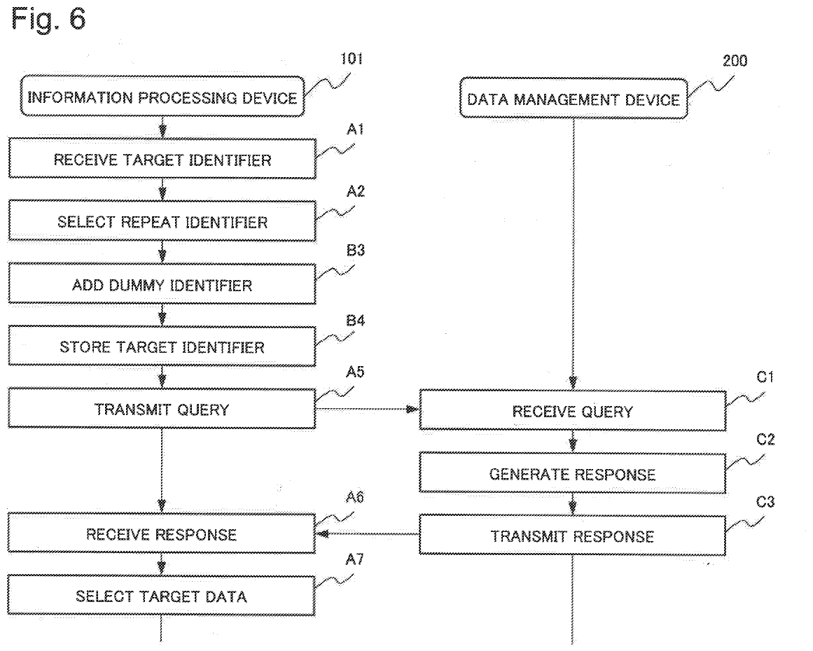

FIG. 6 is a sequence diagram illustrating an example of the operation of the information processing device 101 according to the second example embodiment. As illustrated in FIG. 6, the operation of the information processing device 101 further includes an operation for adding a dummy identifier in B3 of the sequence and an operation for storing a target identifier in B4 of the sequence, as compared with the operation of the information processing device 100. The other operations are similar to those of the first example embodiment. Therefore, detailed description of similar operations will be appropriately omitted and operations associated with the B3 and the B4 of the sequence will be described in detail.

Firstly, the identifier reception unit 120 receives target identifiers (A1).

The identifier selection unit 130 selects repeat identifiers (A2). The identifier selection unit 130 transmits the target identifiers and the repeat identifiers to the identifier transmission unit 140.

The identifier addition unit 170 generates dummy identifiers to be added (B3). The identifier addition unit 170 transmits the dummy identifiers to the identifier transmission unit 140.

Note that the generation operation of the dummy identifier by the identifier addition unit 170 may be performed before the selection operation of the repeat identifier by the identifier selection unit 130. Alternatively, at least a part of the generation operation of the dummy identifier by the identifier addition unit 170 may be performed simultaneously to the selection operation of the repeat identifier by the identifier selection unit 130.

Then, the identifier selection unit 130 or the identifier transmission unit 140 stores the target identifiers in the identifier storage unit 110 (B4). That is, the identifier storage unit 110 stores the target identifiers to be transmitted to the data management device 200 as new identifiers. However, when the identifier storage unit 110 has stored the target identifiers, that is, when the target identifiers have been transmitted to the data management device 200, the identifier selection unit 130 or the identifier transmission unit 140 may not add the target identifiers to the identifier storage unit 110.

Note that the storage of the target identifier needs not to be performed before a query is transmitted. For example, communication between the information processing device 101 and the data management device 200 is not always successful. In this regard, after the identifier transmission unit 140 transmits a query to the data management device 200, the identifier transmission unit 140 may store a communicable target identifier in the identifier storage unit 110.

As described above, it is sufficient if the identifier selection unit 130 or the identifier transmission unit 140 stores the target identifiers in the identifier storage unit 110 at any timing.

The identifier transmission unit 140 transmits a query including the target identifiers, the repeat identifiers, and the dummy identifiers to the data management device 200 (A5). Note that in the query, the identifier transmission unit 140 may change an order of the target identifiers, the repeat identifiers, and the dummy identifiers according to a predetermined rule or in a random manner.

When the number of the target identifiers is set to “I”, the number of the repeat identifiers selected by the identifier selection unit 130 is set to “n”, and the number of the dummy identifiers generated by the identifier addition unit 170 is set to “m (m is an integer equal to or more than 1)”, the query includes I+n+m identifiers. However, the query may include other information.

The data management device 200 operates similarly to the first example embodiment (C1 to C3).

The data reception unit 150 receives data related to the target identifier, the repeat identifier, and the dummy identifier from the data management device 200 (A6).

The data selection unit 160 acquires data related to the target identifier from the received data (A7).

[Description of Effect]

Next, effects of the second example embodiment will be described.

The information processing device 101 according to the second example embodiment further achieves an effect that improves concealment performance of target data in addition to the effects of the information processing device 100 according to the first example embodiment.

The reason for this is because the identifier addition unit 170 of the information processing device 101 adds the dummy identifier, in addition to the target identifier and the repeat identifier, as identifiers to be transmitted to the data management device 200. That is, the information processing device 101 adds the dummy identifier, which is different from the repeat identifier, as an identifier for concealing the target identifier.

The dummy identifier is an identifier different from an identifier transmitted to the data management device 200 in the past. Therefore, even though data related to the target identifier is not included in a past query, the data management device 200 and a third party are not able to distinguish the target identifier and the dummy identifier from each other.

<Hardware Configuration>

The information processing device 100, the information processing device 101, and the information processing device 102 described above are configured as follows.

For example, each element of the information processing device 100, the information processing device 101, and the information processing device 102 may be configured with a hardware circuit.

Furthermore, in the information processing device 100, the information processing device 101, and the information processing device 102, each element may be configured using a plurality of devices connected via a network.

Furthermore, in the information processing device 100, the information processing device 101, and the information processing device 102, a plurality of elements may be configured with one hardware.

Furthermore, the information processing device 100, the information processing device 101, and the information processing device 102 may be realized as a computer device including a central processing unit (CPU) and a read only memory (ROM). Moreover, the information processing device 100, the information processing device 101, and the information processing device 102 may be realized as a computer device including a random access memory (RAM). The information processing device 100, the information processing device 101, and the information processing device 102 may be realized as a computer device further including an input/output circuit (IOC), in addition to the above configuration. The information processing device 100, the information processing device 101, and the information processing device 102 may be realized as a computer device further including a network interface circuit (NIC), in addition to the above configuration.

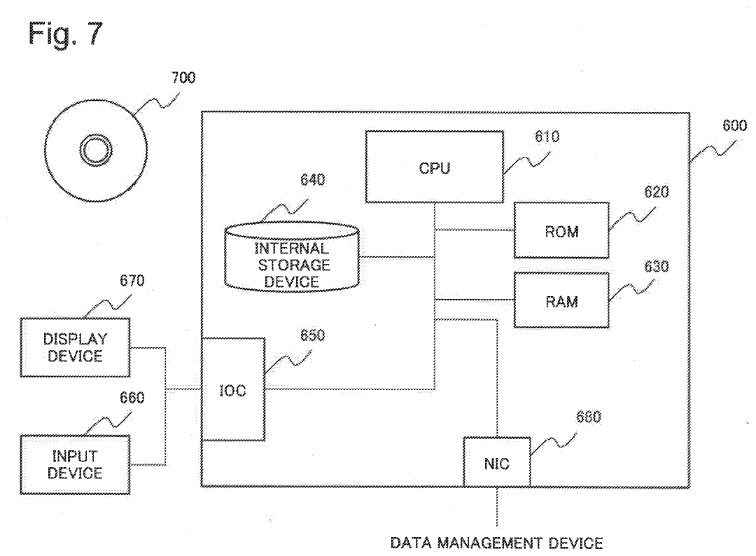

FIG. 7 is a block diagram illustrating an example of a configuration of an information processing device 600 according to an example of the hardware configuration.

The information processing device 600 includes a CPU 610, a ROM 620, a RAM 630, an internal storage device 640, an IOC 650, and a NIC 680, and constitutes a computer device.

The CPU 610 reads a program from the ROM 620. Based on the read program, the CPU 610 controls the RAM 630, the internal storage device 640, the IOC 650, and the NIC 680. Furthermore, a computer including the CPU 610 controls these elements, and performs each function as the identifier reception unit 120, the identifier selection unit 130, the identifier transmission unit 140, the data reception unit 150, and the data selection unit 160 illustrated in FIG. 1. Alternatively, the computer including the CPU 610 controls these elements, and performs each function as the identifier reception unit 120, the identifier selection unit 130, the identifier transmission unit 140, the data reception unit 150, the data selection unit 160, and the identifier addition unit 170 illustrated in FIG. 5. Alternatively, the computer including the CPU 610 controls these elements, and performs each function as the identifier transmission unit 140 and the data selection unit 160 illustrated in FIG. 4.

When performing each function, the CPU 610 may use the RAM 630 or the internal storage device 640 as a temporary storage medium of the program.

Furthermore, the CPU 610 may read a computer readable program, which is included in a storage medium 700, by using a storage medium reading device (not illustrated). Alternatively, the CPU 610 may receive a program from an external device (not illustrated) via the NIC 680, store the received program in the RAM 630, and operate based on the stored program.

The ROM 620 stores a program to be executed by the CPU 610 and fixed data. The ROM 620, for example, is a programmable-ROM (P-ROM) or a flash ROM.

The RAM 630 temporarily stores a program to be executed by the CPU 610 and data. The RAM 630, for example, is a dynamic-RAM (D-RAM).

The internal storage device 640 stores data and a program stored in the information processing device 600 over a long period of time. The internal storage device 640 operates as the identifier storage unit 110. Furthermore, the internal storage device 640 may operate as a temporary storage device of the CPU 610. The internal storage device 640, for example, is a hard drive device, a magneto-optic disk device, a solid state drive (SSD), or a display device.

The ROM 620 and the internal storage device 640 are non-transitory storage mediums. On the other hand, the RAM 630 is a transitory storage medium. The CPU 610 can operate based on the program stored in the ROM 620, the internal storage device 640, and the RAM 630. That is, the CPU 610 can operate by using a non-transitory storage medium or a transitory storage medium.

The IOC 650 mediates data between the CPU 610, and an input device 660 and a display device 670. The IOC 650, for example, is an IO interface card or a universal serial bus (USB) card. Moreover, the IOC 650 is not limited to a wired device such as a USB and may use a wireless device.

The input device 660 is a device that receives an input instruction from a user of the information processing device 600. The input device 20 may operate as the identifier reception unit 120. The input device 660, for example, is a keyboard, a mouse, or a touch panel.

The display device 670 is a device that displays information to a user of the information processing device 600. The display device 670, for example, is a liquid crystal display.

The NIC 680 relays data exchange with an external device (not illustrated) via a network. The NIC 680 operates as a part of the identifier transmission unit 140 and the data reception unit 150. Moreover, the NIC 680 may operate as a part of the identifier addition unit 170. The NIC 680 may operate as the identifier reception unit 120. The NIC 680, for example, is a local area network (LAN) card. Moreover, the NIC 680 is not limited to a wired device and may use a wireless device.

The information processing device 600 configured as above can achieve effects similar to those of the information processing device 100, the information processing device 101, and the information processing device 102.

The reason for this is because the CPU 610 of the information processing device 600 can perform functions similar to those of the information processing device 100, the information processing device 101, and the information processing device 102 based on a program.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-161326, filed on Aug. 19, 2016, the disclosure of which is incorporated herein in its entirety by reference.

### INDUSTRIAL APPLICABILITY

The present invention can be applied to authentication using a network such as a cloud. Particularly, the present invention can be applied to a case where information (for example, a hash value of a biological template or a password), which is related to a user and used for user authentication, is put into a storage placed on a network such as a cloud.

Furthermore, the present invention can be applied to access of data put into a storage placed on a network such as a cloud. Particularly, the present invention can be applied to a password manager that stores and manages passwords, which are used in a plurality of services, in a storage on a network.

### REFERENCE SIGNS LIST

100 Information processing device
101 Information processing device
102 Information processing device
110 Identifier storage unit
120 Identifier reception unit
130 Identifier selection unit
140 Identifier transmission unit
150 Data reception unit
160 Data selection unit
170 Identifier addition unit
200 Data management device
210 Data storage unit
220 Data search unit
300 Information processing system
600 Information processing device
610 CPU
620 ROM
630 RAM
640 Internal storage device
650 IOC
660 Input device
670 Display device
680 NIC
700 Storage medium

What is claimed is:

1. An information processing device comprising:
a memory; and
at least one processor coupled to the memory,
the processor performing operations, the operations comprising:
transmitting a first identifier and a second identifier to a data management device, the second identifier being different from the first identifier and being included in identifiers transmitted to the data management device that stores data in association with an identifier of the data, to the data management device; and
selecting the data related to the first identifier from the data related to the first identifier and the second identifier received from the data management device.

2. The information processing device according to claim 1,
wherein the operations further comprises
selecting a third identifier different from the first identifier and the identifier transmitted to the data management device, and
transmitting the third identifier to the data management device in addition to the first identifier and the second identifier.

3. The information processing device according to claim 2,
wherein the operations further comprises
selecting the third identifier from the identifiers stored in the data management device.

4. The information processing device according to claim 1,
wherein the operations further comprises
receiving the first identifier;
storing the identifiers transmitted to the data management device;
selecting the second identifier from the identifiers stored; and
receiving the data related to the first identifier and the second identifier from the data management device.

5. The information processing device according to claim 4,
wherein the operations further comprises
randomly selecting the second identifier.

6. The information processing device according to claim 4,
wherein the operations further comprises
selecting a predetermined number of second identifiers.

7. The information processing device according to claim 1,
wherein the operations further comprises
authenticating a transmission source that transmits the first identifier based on the data selected.

8. The information processing device according to claim 1,
wherein the data related to the first identifier is a password or biological information which is used for authentication.

9. An information processing method comprising:
transmitting a first identifier and a second identifier to a data management device, the second identifier being different from the first identifier and being included in identifiers transmitted to the data management device that stores data in association with identifiers of the data, to the data management device; and
selecting the data related to the first identifier from the data related to the first identifier and the second identifier received from the data management device.

10. A non-transitory computer-readable recording medium embodying a program, the program causing a computer to perform a method, the method comprising:
transmitting a first identifier and a second identifier to a data management device, the second identifier being different from the first identifier and being included in identifiers transmitted to the data management device that stores data in association with identifiers of the data, to the data management device; and
selecting the data related to the first identifier from the data related to the first identifier and the second identifier received from the data management device.
